(19) United States
(12) Patent Application Publication
(10) Pub. No.: US 2009/0274435 A1
(43) Pub. Date: Nov. 5, 2009

(54) REPRODUCTION DEVICE, REPRODUCTION METHOD, RECORDING DEVICE, RECORDING MEDIUM, PROGRAM STORAGE MEDIUM, AND PROGRAM

(75) Inventors: Yoshiyuki Kobayashi, Tokyo (JP); Motoki Kato, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 11/721,815

(22) PCT Filed: Dec. 2, 2005
(86) PCT No.: PCT/JP2005/022181

§ 371 Date: Jun. 15, 2007

(30) Foreign Application Priority Data
Dec. 15, 2004 (JP) 2004-362230

(51) Int. Cl. H04N 5/91

(52) U.S. Cl. 386/95; 386/E05.003

(57) ABSTRACT

The present invention relates to a reproduction apparatus by which a user can easily search for a desired scene of content data, a reproduction method, a recording apparatus, a recording method, a recording medium, a program storage medium, and a program. Information used for a search is recorded together with content data on an optical disc. The data to be recorded on the optical disc contains at least content data main body, scene description information for displaying a predetermined menu screen on an external display apparatus in the reproduction apparatus. Scene description information is recorded together with the content data on the optical disc, the scene description information being of a data structure in which information indicating an On point and an Out point of the scene and information for each scene in which a plurality of pairs of a search key and a value are defined are contained in amounts corresponding to the number of scenes The present invention can be applied to a recording apparatus a reproduction apparatus, and a recording medium such as an optical disc.

### TECHNICAL FIELD

The present invention relates to a reproduction apparatus, a reproduction method, a recording apparatus, a recording method, a recording medium, a program storage medium, and a program and, more particularly, relates to a reproduction apparatus by which a user can easily search for a desired scene of content data, a reproduction method, a recording apparatus, a recording method, a recording medium, a program storage medium, and a program.

### BACKGROUND ART

In recent years, the recording capacity of a recording medium provided in a recording and reproduction apparatus for recording and reproducing input content data as well as the recording capacity of recording media that can be loaded into a recording and reproduction apparatus has become very large. Users can now record and reproduce many pieces of content or content over long periods of time and enjoy such content.

Recording media on which a plurality of pieces of content and auxiliary information corresponding to the content are recorded in a hierarchical structure in a predetermined directory so that desired content is easily selected from among a large number pieces of content recorded on high-capacity recording media, and reproduction apparatuses for reproducing the recording media are known. In such a reproduction apparatus, there is a technology in which, when a user selects a playlist in which the reproduction sequence of specific content is recorded in order that consumption of time and effort can be reduced, by referring to auxiliary information and by analyzing a data file, a virtual hierarchical structure of a menu/playlist is generated from the data sequence, and is presented to the user in such a manner that all the playlists apparently exist in parallel in the same hierarchy within the hierarchical structure in which menus and playlists coexist, and the user can select a desired playlist with a small number of operations (for example, Patent Document 1).

[Patent Document 1]

Japanese Unexamined Patent Application Publication No. 2004-280996

Examples of start-search functions for easily selection desired content or a desired reproduction start position of desired content from among a large number of pieces of content recorded on a high-capacity recording medium are a title search for searching for desired content on the basis of the title of content, a chapter search for searching for a desired reproduction start position on the basis of a chapter marked within the content by the user or by the provider of the content, a track search for searching for a desired reproduction start position on the basis of a track number, and a time search for searching for a desired reproduction start position on the basis of time information. These functions are implemented by attaching a bookmark to the reproduction time axis of content data to be reproduced.

### DISCLOSURE OF INVENTION

### Problems to be Solved by the Invention

However, in order for the user to be able to select a desired playlist with a small number of operations by means of the above-described related art (for example, Patent Document 1), it is necessary for the reproduction apparatus to perform a complex analysis process and generate a virtual. hierarchical structure. In such a cases a playlist that has already been formed as a file can be selected by the user For example, in order to select a desired position within a playlist as a reproduction start position, a different operation is necessary.

On the other hand, when various kinds of search functions implemented by attaching so-called bookmarks to the reproduction time axis of content data to be reproduced are used, the user can select a desired position within the content as a reproduction start position. However, since the bookmarks are attached in a one-dimensional manner so as to correspond to the reproduction time axis, it has been difficult to form a hierarchical navigation screen for selecting a desired reproduction start position.

More specifically, for example, when date is used as a search key, since a maximum of 365 items can exist in the same hierarchy it is very difficult to present all these items to the user, considering that the items are in the same hierarchy. However, by assuming that many items are in the same hierarchy, the hierarchy can be presented, for example, as a navigation screen to the user. As a result, it is difficult to generalize a hierarchy and folding of items regardless of the search key and it is difficult to define a protocol. Therefore, the structure of the navigation screen that is formed as a hierarchy, the navigation screen being used to select a desired reproduction start position by the user, has been dependent on the implementation of the recording and reproduction apparatus. For this reason, compatibility for a hierarchy among recording and reproduction apparatuses has not been guaranteed.

The present invention has been made in view of such circumstances, and aims to make searching for a desired scene of content data by a user easy.

### Means for Solving the Problems

A first reproduction apparatus according to the present invention is a reproduction apparatus for reproducing content data containing a plurality of scenes, the content data being recorded on a recording medium, the reproduction apparatus including an operation input section configured to accept an operation input by a user; an obtaining section configured to reproduce and obtain, from the recording medium, information including the start point information and the end point information of the scene contained in the content data recorded on the recording medium, keys used to search for the scene, and key values corresponding to the keys; a display controller configured to control the display of a display screen on the basis of the keys and the key values obtained by the obtaining section; a hierarchy organization section configured to organize a virtual hierarchical structure of the keys on the basis of the operation input by the user, the operation being input by means of the operation input section; and a reproduction controller configured to control the reproduction output of a predetermined scene included in the content data recorded on the recording medium on the basis of the operation input by the user by means of the operation input section and on the basis of the information, wherein the display controller controls the display of a first display screen with which the user selects one of the keys obtained by the obtaining section, the hierarchy organization section organizes a virtual hierarchical structure of the keys on the basis of the key selected by the user who has referred to the first display screen whose display is controlled by the display controller, the key being operated and input by means of the operation input section, the display controller controls the display of a second display screen with which the user selects one of the key values corresponding to the keys in accordance with the virtual hierarchical structure of the keys, the virtual hierarchical structure being organized by the hierarchy organization section, and the reproduction controller detects the start point information and the end point information of a predetermined scene corresponding to the key value on the basis of the key value selected by the user who has referred to the second display screen whose display is controlled by the display controller and on the basis of the information, the key being operated and input by means of the operation input section, and controls the reproduction output of the predetermined scene.

The reproduction apparatus can further include a thumbnail image data generator configured to generate thumbnail image data corresponding to each of the scenes on the basis of the start point information contained in the information and the content data. The display controller can further control the display of a thumbnail image corresponding to the thumbnail image data generated by the thumbnail image data generator.

The reproduction apparatus can further include thumbnail image data corresponding to the scene. The reproduction apparatus can further include a thumbnail image data obtaining section configured to obtain the thumbnail image data contained in the information. The display controller can further control the display of a thumbnail image corresponding to the thumbnail image data obtained by the thumbnail image data obtaining section.

In addition to the content data and the information, management information for managing the content data can further be recorded on the recording medium.

The management information can contain information indicating the reproduction start position and the reproduction completion position in predetermined reproduction units containing at least one scene.

The information can be described in XML.

A first reproduction method according to the present invention is a reproduction method for use in a reproduction apparatus for reproducing content data containing a plurality of scenes the content data being recorded on a recording medium, the reproduction method including: an obtainment control step of controlling the obtainment, from the recording medium, information including the start point information and the end point information of the scene contained in the content data recorded on the recording medium, keys used to search for the scene, and key values corresponding to the keys; a first display control step of controlling the display of a first display screen with which the user selects one of the keys whose obtainment is controlled by the process of the obtainment control step; a hierarchy organization step of organizing a virtual hierarchical structure of the keys on the basis of the key selected by the user who has referred to the first display screen whose display is controlled by the process of the first display control step; a second display control step of controlling the display of a second display screen with which the user selects one of the key values corresponding to the keys on the basis of the virtual hierarchical structure of the keys, the virtual hierarchical structure being organized by the process of the hierarchy organization step; a detection step of detecting the start point information and the end point information of a predetermined scene corresponding to the key value on the basis of the key value selected by the user who has referred to the second display screen whose display is controlled by the second display control step and on the basis of the information; and a reproduction control step of extracting the predetermined scene and controlling the reproduction output of the predetermined scene on the basis of the start point information and the end point information of the predetermined scene detected by the process of the detection step.

A program stored on a first program storage medium according to the present invention is a program storage medium having recorded thereon a program for enabling a computer to perform a process for reproducing content data containing a plurality of scenes, the content data being recorded on a recording medium, the process including an obtainment control step of controlling the obtainment, from the recording medium, information including the start point information and the end point information of the scene contained in the content data recorded on the recording medium, keys used to search for the scene, and key values corresponding to the keys; a first display control step of controlling the display of a first display screen with which the user selects one of the keys whose obtainment is controlled by the process of the obtainment control step; a hierarchy organization step of organizing a virtual hierarchical structure of the keys on the basis of the key selected by the user who has referred to the first display screen whose display is controlled by the process of the first display control step; a second display control step of controlling the display of a second display screen with which the user selects one of the key values corresponding to the keys on the basis of the virtual hierarchical structure of the keys, the virtual hierarchical structure being organized by the process of the hierarchy organization step; a detection step of detecting the start point information and the end point information of a predetermined scene corresponding to the key value on the basis of the key value selected by the user who has referred to the second display screen whose display is controlled by the second display control step and on the basis of the Information; and a reproduction control step of extracting the predetermined scene and controlling the reproduction output of the predetermined scene on the basis of the start point information and the end point information of the predetermined scene detected by the process of the detection step.

A first program according to the present invention is a program for enabling a computer to perform a process for reproducing content data containing a plurality of scenes the content data being recorded on a recording medium, the process including: an obtainment control step of controlling the obtainment, from the recording medium, information including the start point information and the end point information of the scene contained in the content data recorded on the recording medium, keys used to search for the scene, and key values corresponding to the keys; a first display control step of controlling the display of a first display screen with which the user selects one of the keys whose obtainment is controlled by the process of the obtainment control step; a hierarchy organization step of organizing a virtual hierarchical structure of the keys on the basis of the key selected by the user who has referred to the first display screen whose display is controlled by the process of the first display control step; a second display control step of controlling the display of a second display screen with which the user selects one of the key values corresponding to the keys on the basis of the virtual hierarchical structure of the keys, the virtual hierarchical structure being organized by the process of the hierarchy organization step; a detection step of detecting the start point information and the end point information of a predetermined scene corresponding to the key value on the basis of the key value selected by the user who has referred to the second display screen whose display is controlled by the second display control step and on the basis of the information; and a reproduction control step of extracting the predetermined scene and controlling the reproduction output of the predetermined scene on the basis of the start point information and the end point information of the predetermined scene detected by the process of the detection step.

In the first reproduction apparatus, the first reproduction method and the first program according to the present invention, information including the start point information and the end point; information of a scene contained in the content data recorded on a recording medium, a key used to search for a scene, and a key value corresponding to the key is obtained from the recording medium. A first display screen to be used by the user to select one of the obtained keys is displayed On the basis of the key selected by the user who has referred to the first display screen, a virtual hierarchical structure of keys is organized. On the basis of the organized virtual hierarchical structure of keys, a second display screen to be used by the user to select one of the key values corresponding to the keys is displayed. On the basis of the key value selected by the user who has referred to the second display screen and the information, the start point information and the end point information of a predetermined scene corresponding to the key value are detected, and a predetermined scene is extracted and reproduced.

A second reproduction apparatus according to the present invention is a reproduction apparatus capable of reproducing content data formed of data in predetermined reproduction units defined by management information the content data being recorded on a recording medium, the reproduction apparatus including an obtaining section configured to obtain the start point information and the end point information of a scene contained in the content data on the basis of description information recorded together with the content data and the management information on the recording medium; and a reproduction controller configured to reproduce the content data on the basis of the start point information and the end point information obtained by the obtaining section, wherein the predetermined reproduction units constituting the content data contain at least one scene divided by the start point information and the end point information.

The start point information and the end point information can be described in XML.

A second reproduction method according to the present invention is a reproduction method for use in a reproduction apparatus for reproducing content data formed of data in predetermined reproduction units defined by management information, the content data being recorded on a recording medium, the reproduction method including: an obtainment control step of controlling the obtainment of the start point information and the end point information of a scene contained in the content data on the basis of description information recorded together with the content data and the management information on the recording medium; and a reproduction control step of reproducing the content data on the basis of the start point information and the end point information obtained by the process of the obtainment control step, wherein the predetermined reproduction units constituting the content data contain at least one scene divided by the start point Information and the end point information.

A program stored on a second program storage medium according to the present invention is a program storage medium having recorded thereon a program for enabling a computer to perform a process for reproducing content data formed of data in predetermined reproduction units defined by management information, the content data being recorded on a recording medium, the process including: an obtainment control step of controlling the obtainment of the start point information and the end point information of a scene contained in the content data on the basis of description information recorded together with the content data and the management information on the recording medium; and a reproduction control step of reproducing the content data on the basis of the start point information and the end point information obtained by the process of the obtainment control step.

A second program according to the present invention is a program for enabling a computer to perform a process for reproducing content data in predetermined reproduction units defined by management information, the content data being recorded on a recording medium, the process including: an obtainment control step of controlling the obtainment of the start point information and the end point information of a scene contained in the content data on the basis of description information recorded together with the content data and the management information on the recording medium; and a reproduction control step of reproducing the content data on the basis of the start point information and the end point information obtained by the process of the obtainment control step.

In the second reproduction apparatus, the second reproduction method, and the second program according to the present invention, the start point information and the end point information of a scene contained in predetermined reproduction units of content data are obtained from the description information recorded together with content data and management information on a recording medium. On the basis of the obtained start point information and the end point information, the content data is reproduced. The predetermined reproduction units constituting the content data contain at least one scene divided by the start point information and the end point information.

The recording apparatus according to the present invention includes: a first obtaining section configured to obtain the content data; a second obtaining section configured to obtain information including the start point information and the end point information of a scene contained in the content data, keys used to search for the scene, and key values corresponding to the keys; and a recorder for recording the information obtained by the second obtaining section together with the content data obtained by the first obtaining section on the recording medium.

The information can be described in XML.

The second obtaining section can further obtain management information of the content, and the recorder can further record the management information together with the scene description information and the content data on the recording medium.

In the recording apparatus of the present invention, content data is obtained. Information including the start point information and the end point information of a scene contained in the content data, keys used to search for the scene, and key values corresponding to the keys is obtained. The obtained information, together with the obtained content data, is recorded on a recording medium.

The recording medium of the present invention can be loaded into a predetermined reproduction apparatus and is a recording medium on which content data that can be reproduced by the reproduction apparatus is recorded. Information including the start point information and the end point information of a scene contained in the content data, keys used to search for the scene, and key values corresponding to the keys is recorded so as to be associated with the content data.

The information can be described in XML

On the recording medium of the present invention, which can be loaded into a predetermined reproduction apparatus and on which content data that can be reproduced by the reproduction apparatus is recorded, information including the start point information and the end point information of a scene contained in the content data, keys used to search for the scene, and key values corresponding to the keys is recorded so as to be associated with the content data.

### Advantages

According to a first aspect of the present invention, content recorded on a recording medium can be reproduced. In particular/on the basis of information including the start point information and the end point information of a scene contained in the content data, keys used to search for the scene, and key values corresponding to the keys, a virtual hierarchical structure of keys is formed. Since a display screen for selecting a key value is displayed on the basis of the information, it is possible for the user to easily search for a desired scene.

According to a second aspect of the present invention, content recorded on a recording medium can be reproduced. In particular, it is possible to search for a scene and reproduce it in units smaller than divisions smaller than a predetermined reproduction unit set in content data using management information.

According to a third aspect of the present invention, content can be recorded on a recording medium. In particular, since information including the start point information and the end point information of a scene contained in the content data, keys used to search for the scene, and key values corresponding to the keys, together with content, is recorded on a recording medium it is possible for the user who reproduces content recorded on the recording medium to easily search for a desired scene.

According to a fourth aspect of the present invention, since a recording medium on which information including the start point information and the end point information of a scene contained in content data, keys used to search for the scene, and key values corresponding to the keys is recorded can be provided, it is possible for the user who reproduces content recorded on the recording medium to easily search for a desired scene.

### BRIEF DESCRIPTION OF THE DRAWINGS

FIG. 1 is a block diagram showing the configuration of a recording apparatus to which an embodiment of the present invention is applied.

FIG. 2 is an illustration of scene description information to be recorded on an optical disc by the recording apparatus of FIG. 1.

FIG. 3 is an illustration of scene description information to be recorded on an optical disc by the recording apparatus of FIG. 1.

FIG. 4 is an illustration of scene description information to be recorded on an optical disc by the recording apparatus of FIG. 1.

FIG. 5 is an illustration of description in the form of a table of scene description information.

FIG. 6 is an illustration of description in the form of a table of scene description information.

FIG. 7 is a block diagram showing the configuration of a reproduction apparatus to which an embodiment of the present invention is applied.

FIG. 8 is a function block diagram illustrating functions possessed by the reproduction apparatus of FIG. 7.

FIG. 9 is an illustration of a top navigation key selection screen.

FIG. 10 is an illustration of a key value selection screen.

FIG. 11 is an illustration of a key value selection screen.

FIG. 12 is an illustration of a key value selection screen.

FIG. 13 is a flowchart illustrating a recording process.

FIG. 14 is a flowchart illustrating a reproduction process.

FIG. 15 is a flowchart illustrating a reproduction process.

FIG. 16 is an illustration of an example of navigation that can be implemented.

FIG. 17 is an illustration of an example of navigation that can be implemented.

FIG. 18 is an illustration of an example of navigation that can be implemented.

FIG. 19 is an illustration of the data structure of an AV stream recorded on an optical disc.

FIG. 20 is an illustration of an example of the application format of content.

FIG. 21 is an illustration of an example of scene description information described in a table format.

FIG. 22 is an illustration of a data structure when the scene description information of FIG. 21 is written in a well-formed XML format.

FIG. 23 is an illustration of the hierarchical structure of a navigation menu in the data structure of FIG. 22.

FIG. 24 is an illustration of the definition of ScenestartTime.

FIG. 25 is an illustration of a type representation of SceneStartTime in an XML schema.

FIG. 26 is an illustration of the data structure using a tagged language in an XML format.

FIG. 27 is an illustration of a data structure using a tagged language in an XML format.

FIG. 28 is an illustration of a data structure using a tagged language in an XML format.

### REFERENCE NUMERALS

1 recording apparatus, 11 optical disc, 21 controller, 23 data obtaining section, 26 recording controller, 41 reproduction apparatus, 51 controller, 52 operation input section, 54 reproduction controller, 56 decoder, 81 scene description information obtaining section, 82 thumbnail image data obtainer/generator, 83 operation input obtaining section, 84 navigation hierarchy controller, 85 navigation screen display controller, 86 reproduction controller, 101 top navigation key selection screen, 121, 141, 161 key value selection screen

### BEST MODE FOR CARRYING OUT THE INVENTION

Embodiments of the present invention will now be described below with reference to the drawings.

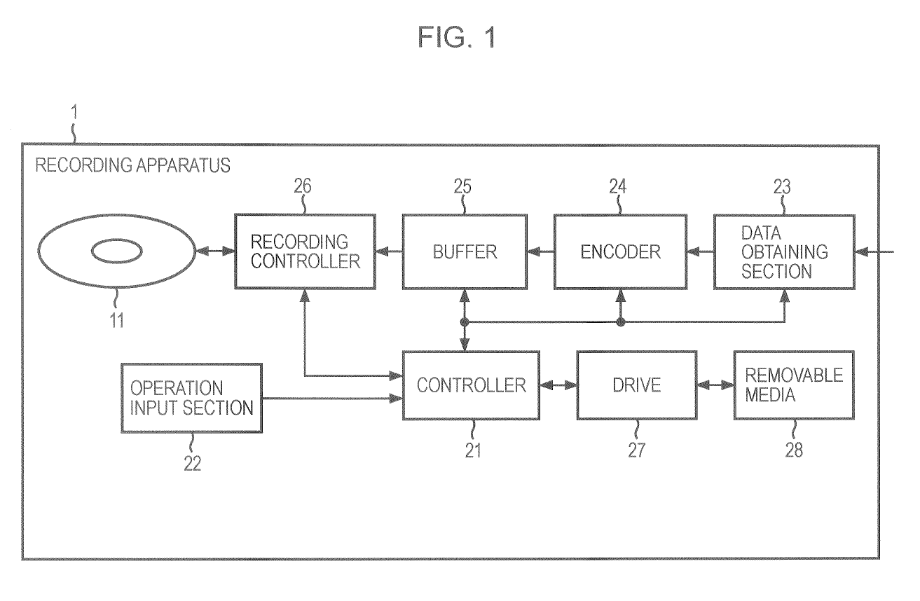

FIG. 1 is a block diagram showing an example of the configuration of a recording apparatus 1 according to a first embodiment to which the present invention is applied.

A controller 21 controls the entire operation of the recording apparatus 1 by executing a control program that is provided in advance. For example, the controller 21 can control processes for recording content data on an optical disc 11, which is a loaded recording medium, for allowing an external display apparatus to display a predetermined menu screen in a reproduction apparatus (to be described later), and for recording scene description information or the like with which a user can easily search for a scene. The details of the scene description information will be described later.

An operation input section 22 is constituted by an input device such as a button, a key, a touch panel, a jog dial, or a mouse, and a receiver for receiving an infrared signal or the like to be transmitted from a predetermined remote commander, obtains operation input by a user, and supplies it to the controller 21.

A data obtaining section 23 obtains content data, scene description information (to be described later), or the like from the outsides and supplies them to an encoder 24. The encoder 24 encodes the supplied data and supplies it to a buffer 25. The buffer 25 temporarily buffers the encoded data and supplies it to a recording controller 26.

Under the control of the controller 21, the recording controller 26 records the data supplied from the buffer 25 or the controller 21 on the optical disc 11.

A drive 27 is also connected to the controller 21 as necessary. For example, a removable medium 28 formed of a magnetic disk (including a flexible disk), an optical disc (CD-ROM (Compact Disk-Read Only Memory) including a DVD), a magneto-optical disc (including an MD (registered trademark) (Mini-Disk)), a semiconductor memory, or the like, is loaded into the drive 27.

The recording medium for recording content may be, for example, a magnetic disk or a semiconductor memory in addition to the optical disc 11.

Next, a description will be given of data to be recorded on the optical disc 11 by the recording apparatus 1 described with reference to FIG. 1.

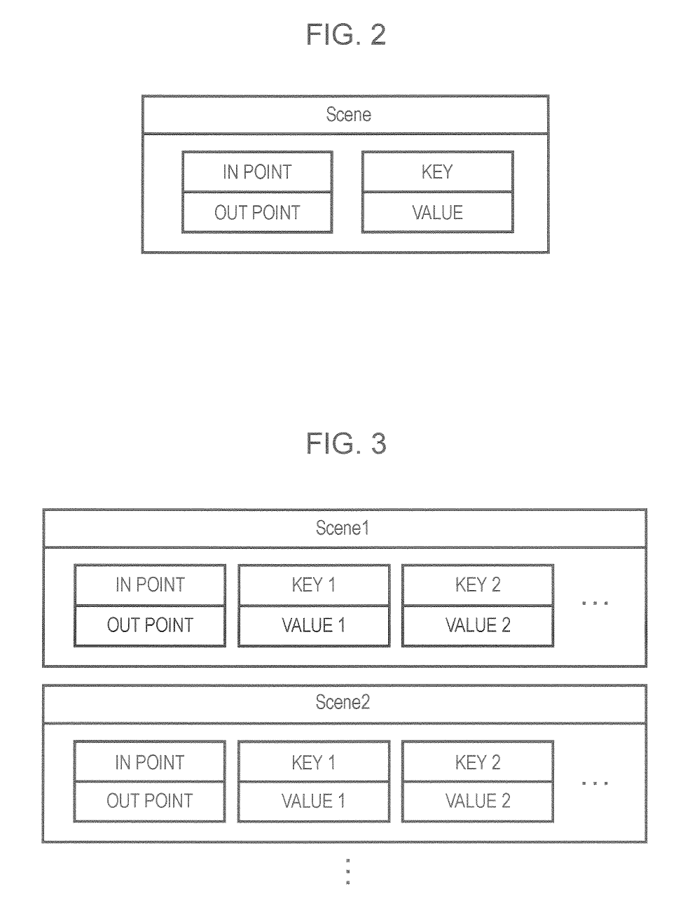

The data recorded on the optical disc 11 by the recording apparatus 1 described with reference to FIG. 1 contains at least a main content data body, and scene description information with which a predetermined menu screen is displayed on an external display apparatus in the reproduction apparatus (to be described later) and the user can easily search for a desired scene. As shown in FIG. 2, the scene description information is information including information indicating an IN point and an OUT point of the scene, and a pair of a search key and a value corresponding to the key (hereinafter referred to as a value or a key value) for each scene, which is a basic unit of a search As shown in FIG. 2, in the scene description information, as time information for each scene, not only the IN point, but also the OUT point can be defined. The pair of the key and the value can be defined as, for example, “player name”, “Ichiro” and “date”, “2004 Apr. 1”, and a plurality of pairs of the key and the value can be defined in one scene.

Therefore, as shown in FIG. 3, by using the recording apparatus 1 of FIG. 1, the content producer records scene description information, together with content data, on the optical disc 11, the scene description information being of a data structure in which information indicating the IN point and the OUT point of the scene and information for each scene in which a plurality of pairs of a key and a value are defined are contained in amounts corresponding to the number of scenes.

In the scene description information, a thumbnail image that represents the content of a scene or that corresponds to the video image at the IN point for each scene may be contained. Furthermore, the copyright or billing data attributes may be attached to the scene description information. By attaching the copyright or billing data attributes to the scene description information it is possible to introduce copyright management in units of scenes.

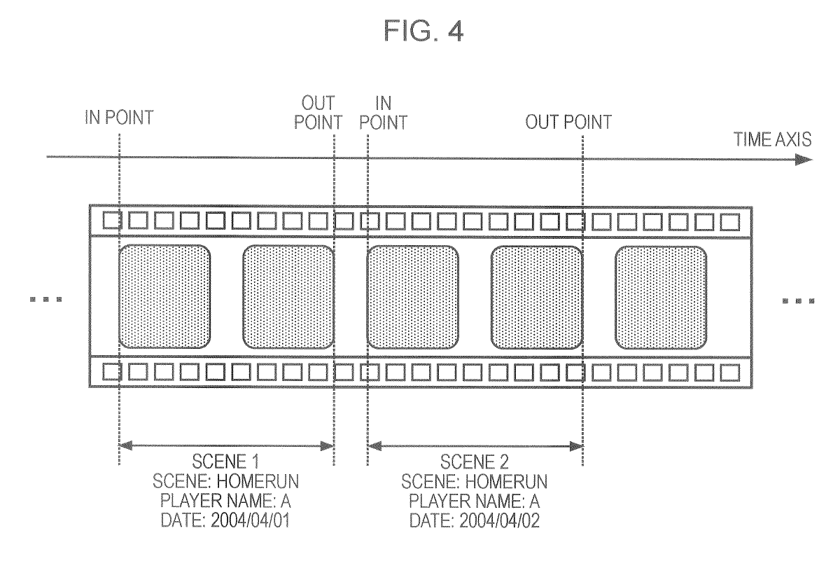

A description will now be given, with reference to FIG. 4, of the correspondence between content data (for example, AV (Audio Visual) stream data) and scene description information.

Content data contains scenes that are basic units of a search. That is, the content data is formed in such a manner that a plurality of scenes are arranged in the time axis. The time information indicating the start point of the scene is information of the IN point, and the time information indicating the end point of the scene is information of the OUT point. A scene ID is attached for each scene so as to be distinguishable and at least one pair of a key and a value corresponds to each scene. In FIG. 4, three keys of a scene, a player name, and date correspond to each scene. In a scene 1 of a scene ID1, a value “homerun” is associated with a key “scene”, a value “A” is associated with a key “player name” and a value “2004 Apr. 1” is associated with a key “date”. In a scene 2 of a scene ID2, a value “homerun” is associated with a key “scene”, a value “A” is associated with a key “player name”, and a value “2004 Apr. 1” is associated with a key “date”.

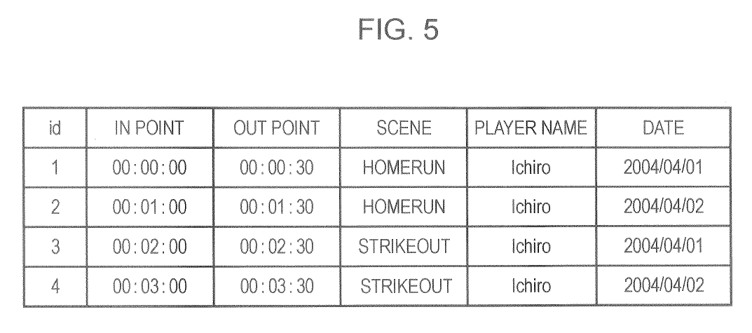

Such scene description information is represented in a table format in, for example, FIG. 5. That is, a record is generated for each scene ID, and information on the IN point and the OUT point, and the respective values for the keys scene, “player name”, and “date” are recorded in the corresponding fields.

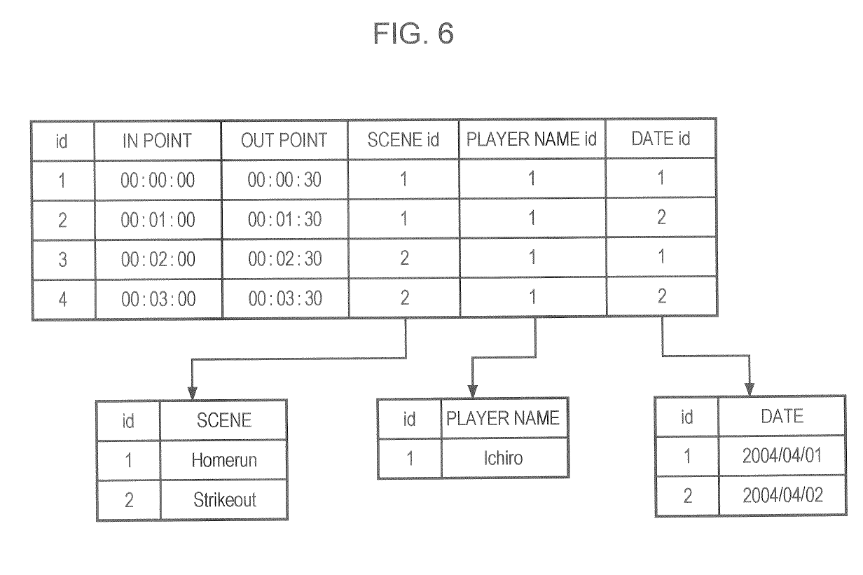

However, in actual data definition, since duplicate data is removed to eliminate data redundancy, a relational database structure, as shown in FIG. 6, is formed. That is, the respective values for the keys “scene”, “player name”, and “date” are written in the scene ID, the player name ID, and the date ID. The scene ID, the player name ID, and the date ID are defined in another table.

As described above, in the recording apparatus 1 described with reference to FIG. 1, the above-described scene description information, together with the content data, is recorded on the optical disc 11.

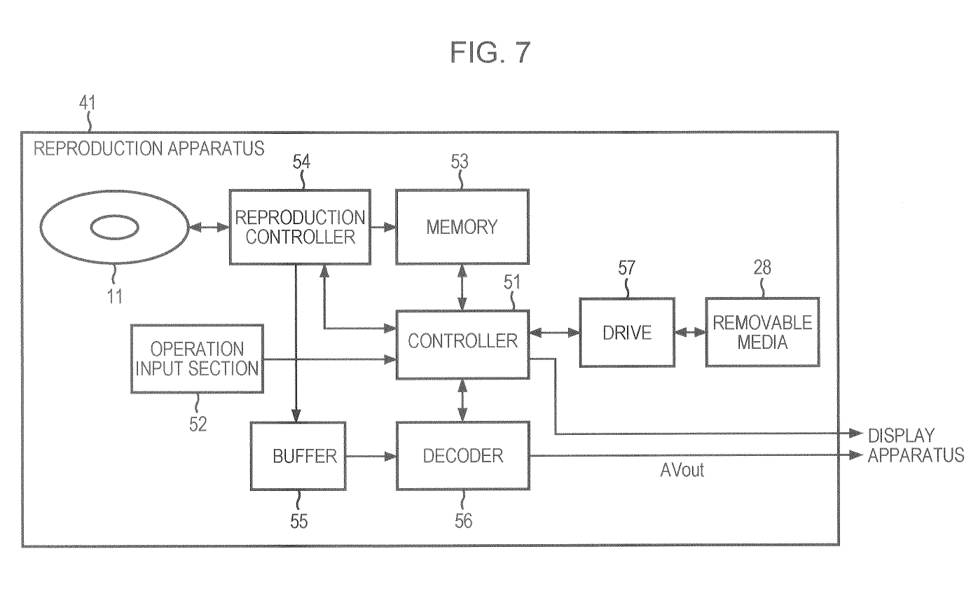

FIG. 7 is a block diagram showing an example of the configuration of a reproduction apparatus 41 according to the first embodiment to which the present invention is applied.

A controller 51 controls the entire operation of the reproduction apparatus 41 by executing a control program that is provided in advance on the basis of an operation input by the user from an operation input section 52 or by controlling a reproduction controller 54 in order to read a control program recorded on the optical disc 11, loading it into a memory 53, and executing it. For example, when the optical disc 11 is loaded, it is possible for the controller 51 to allow an external display apparatus to display a predetermined menu screen.

The operation input section 52 includes, for example, input devices, such as a button, a key, a touch panel, a log dial, and a mouse, and a receiver for receiving an infrared signal or the like transmitted from a predetermined remote commander obtains operation input by a user, and supplies it to the controller 51.

The memory 53 stores, as appropriates data and the like necessary for the controller 51 to perform various kinds of processing.

Under the control of the controller 51, the reproduction controller 54 reads data from the optical disc 11 and outputs it to a buffer 55 so that the read data is supplied to the controller 51, the memory 53, or a decoder 56. When the information read from the optical disc 11 is a control program, control information, scene description information, or a playlist (to be described later), the information read by the reproduction controller 54 is output to the controller 51 or the memory 53. When the information read from the optical disc 11 is content data, such as an AV stream, the information read by the reproduction controller 54 is output to the buffer 55 so that the information is supplied to the decoder 56.

The buffer 55 temporarily buffers content data, such as an AV stream read from the optical disc 11, and supplies it to the decoder 56.

The decoder 56 decodes content data, such as an AV stream supplied from the reproduction controller 54, and outputs a video signal and an audio signal that are obtained to an external display apparatus On the display apparatus, on the basis of the signal decoded by the decoder 56, for example, content recorded on the optical disc 11 is output (video image is displayed, audio is output).

Furthermore, a drive 57 is also connected to the controller 51 as necessary. The removable medium 28 formed of a magnetic disk (including a flexible disk), an optical disc (CD-ROM (Compact Disk-Read Only Memory), including a DVD), a magneto-optical disc (including an MD (registered trademark) (Mini-Disk)), a semiconductor memory, or the like, is loaded into the drive 57.

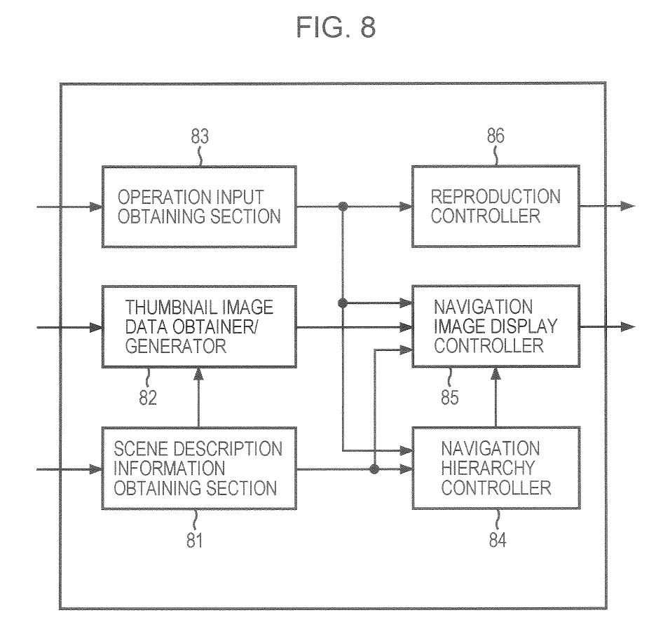

FIG. 8 is a function block diagram illustrating functions that can be implemented by a control program executed by the controller 51 of the reproduction apparatus 41.

A scene description information obtaining section 81 obtains scene description information reproduced by the reproduction controller 54 from the optical disc 11, and supplies it to a thumbnail image data obtainer/generator 82 and a navigation hierarchy controller 84.

The thumbnail image data obtainer/generator 82 generates thumbnail image data by obtaining thumbnail image data contained in the scene description information or by extracting image data of a frame corresponding to the time information at the IN point in video data within the content data decoded by the decoder 56 after being is reproduced from the optical disc 11 from the reproduction controller 54 on the basis of the information of the IN point contained in the scene description information and is buffered in the buffer 55, and supplies the obtained or generated thumbnail image data to a navigation screen display controller 85.

The operation input obtaining section 83 obtains an operation input by the user using the operation input section 52, and supplies it to the navigation hierarchy controller 84, the navigation screen display controller 85, and a reproduction controller 86.

On the basis of the operation input by the user, which is obtained and supplied by the operation input obtaining section 83, the navigation hierarchy controller 84 controls the sequence in which a value within the keys defined by the scene description information supplied from the scene description information obtaining section 81 is selected by the user, that is, the structure of the virtual hierarchical structure of keys, which is presented to the user, and supplies information indicating the organized hierarchical structure to the navigation screen display controller 85.

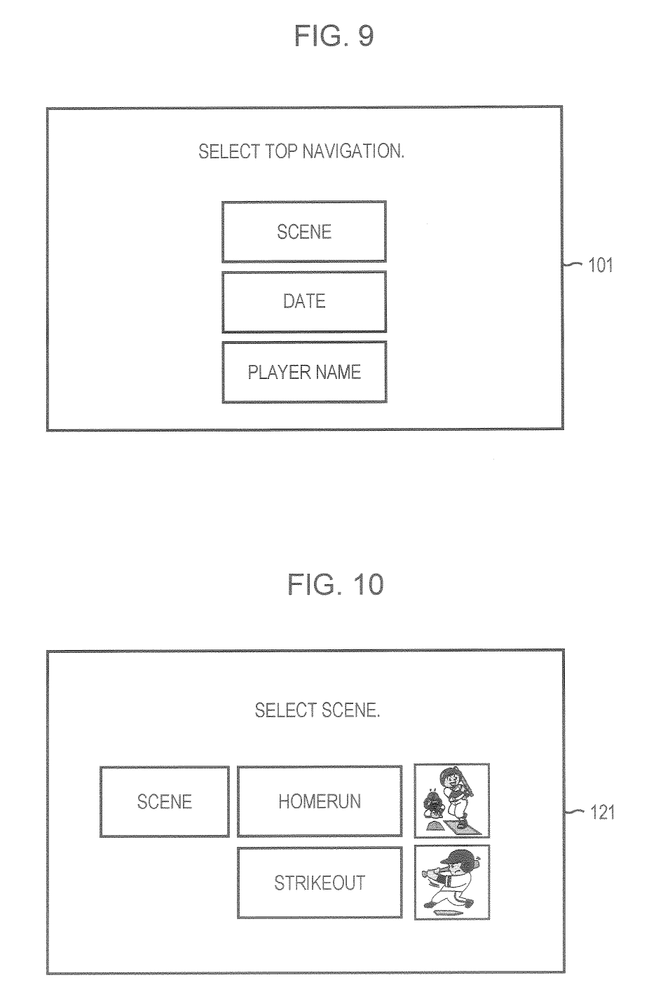

On the basis of the information indicating the hierarchical structure supplied from the navigation hierarchy controller 84, the navigation screen display controller 85 controls the display of the navigation screen presented to the user. Examples of the navigation screen will be described later with reference to FIGS. 9 to 12.

On the basis of the operation input by the user, which is obtained and supplied from the operation input obtaining section 83, the reproduction controller 86 controls the reproduction of the content data.

Next, a description will be given, with reference to FIGS. 9 to 12, of a navigation screen displayed on an external display apparatus by the process of the controller 51.

The navigation screen display controller 85 generates display screen data corresponding to the top navigation key selection screen used for the user to select one of the keys as a key to be selected with priority among the keys contained in the scene description information supplied from the scene description information obtaining section 81, and controls the display.

For example, when the three keys contained in the scene description information supplied from the scene description information obtaining section 81 are “scene”, “date”, and “player name”, the navigation screen display controller 85 controls, for example, the display of the top navigation key selection screen 101 shown in FIG. 9 such that the user can select one of the three keys.

Then, when the operation input obtaining section 83 obtains an operation input indicating that one of the keys is selected by the user who has referred to the top navigation key selection screen 101 the navigation screen display controller 85 extracts a value associated with the selected key in the scene description information supplied from the scene description information obtaining section 81, generates display screen data corresponding to the key value selection screen on which a list of the extracted values are displayed, and controls the display.

For example, when an input of an operation for selecting a key “scene”, is obtained by the operation input obtaining section 83 the navigation screen display controller 85 extracts values “homerun” and “strikeout” associated with the key “scene” from within the scene description information supplied from the scene description information obtaining section 81, and controls, for example, the display of the key value selection screen 121 shown in FIG. 10 such that the user can select one of the two values. Furthermore, on the key value selection screen 121, a thumbnail image that is obtained or generated by the thumbnail image data obtainer/generator 82 or that corresponds to the displayed key value may be displayed in such a manner as to be associated with the key value.

When the operation input obtaining section 83 obtains an operation input indicating that one of the values is selected by the user who has referred to the key value selection screen 121, the navigation screen display controller 85 generates display screen data corresponding to the key value selection screen to be used by the user to select one of the keys that have not yet been selected and controls the display.

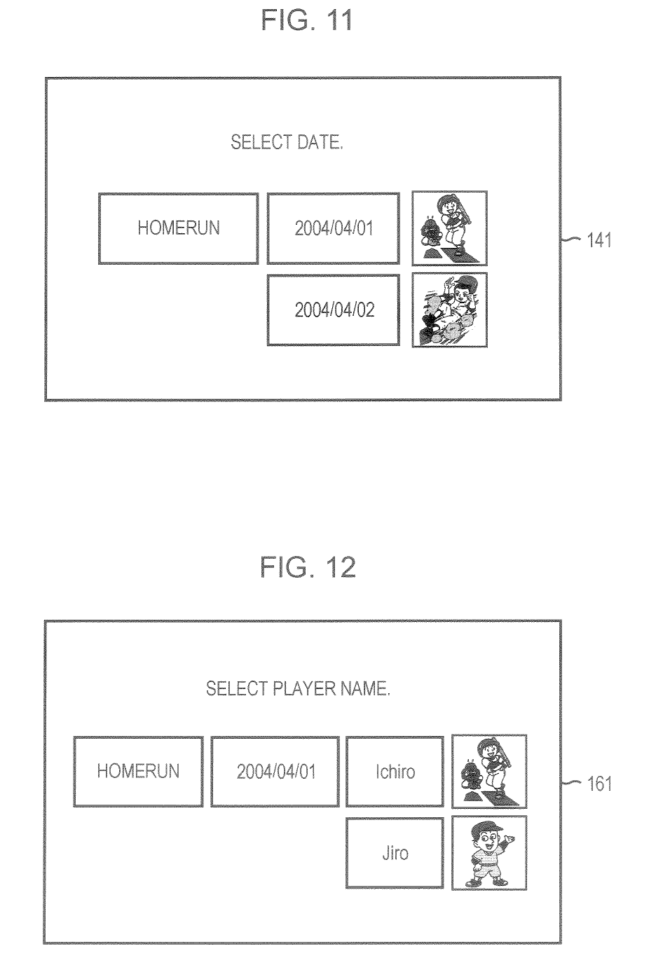

For example, when the two keys whose values have not yet been selected by the user among the keys contained in the scene description information supplied from the scene description information obtaining section 81 are “date” and “player name”, the navigation screen display controller 85 extracts, for the user, the values “2004 Feb. 2” and “2004 Feb. 2” associated with the key “date” among the two keys, and controls, for example, the display of the key value selection screen 141 shown in FIG. 11 such that the user can select one of the two values. At this time, on the key value selection screen 141, the key values of the keys that have already been selected (here, a value “homerun” associated with the “scene”) may be displayed. Furthermore, on the key value selection screen 141, thumbnail images corresponding to the displayed key values, which are obtained or generated by the thumbnail image data obtainer/generator 82, may be displayed in such a manner as to be associated with the key values.

The key value selection screen is repeatedly displayed in such a manner as to be associated with each key until the values corresponding to all the keys contained in the scene description information are selected by the user. That is, when the key whose value has not yet been selected by the user becomes only the “player name” among the keys contained in the scene description information supplied from the scene description information obtaining section 81, the navigation screen display controller 85 extracts the values “Ichiro”and “Jiro” that are associated with the key “player name” for the user, and controls, for examples the display of the key value selection screen 161 shown in FIG. 12 such that the user can select one of the two values. At this time, on the key value selection screen 161, the key values of the keys that have already been selected (here, a value “homerun” associated with the “scene”, and a value “2004 Feb. 1” associated with “date”) may also be displayed. Furthermore, on the key value selection screen 161, thumbnail images corresponding to the displayed key values, which are obtained or generated by the thumbnail image data obtainer/generator 82, may be displayed in such a manner as to be associated with the key values.

Then, the reproduction controller 86 searches for a scene desired by the user on the basis of the value corresponding to each key selected by the user, and controls the reproduction of the scene or the presentation of the found scene to the user. That is, when the values corresponding to each key selected by the user are, for example, “homerun”, “2004 Feb. 1” and “Ichiro”, the reproduction controller 86 refers to the scene description information, extracts scenes having the value of “homerun”, “2004 Feb. 1”, or “Ichiro”, and controls the reproduction of the scene or the presentation of the found scene to hi-e user on the basis of the IN point information and the OUT point information of the scene.

In the manner described above, when the user searches for a desired scene, a GUI such that the user can determine the sequence of the hierarchically organized navigation is displayed The sequence of the hierarchically organized navigation can be easily determined so that the user can intuitively search for a scene desired by the user himself/herself by referring to the display screen.

A virtual hierarchical structure of keys is generated using top navigation keys selected by the user, and on the basis of the hierarchical structure, the sequence of the display of the display screen to be used by the user to select the value corresponding to the key is controlled. The scene to be searched for is determined by the key value selected by the user regardless of the type of top navigation key or the virtual hierarchical structure. In other words, the selection of the key value by the user is made on the basis of the virtual hierarchical structure For the search process, each time the user selects one key value, a process for extracting a record having the key value does not need to be performed, and records having the key value should preferably be extracted after all the key values are selected

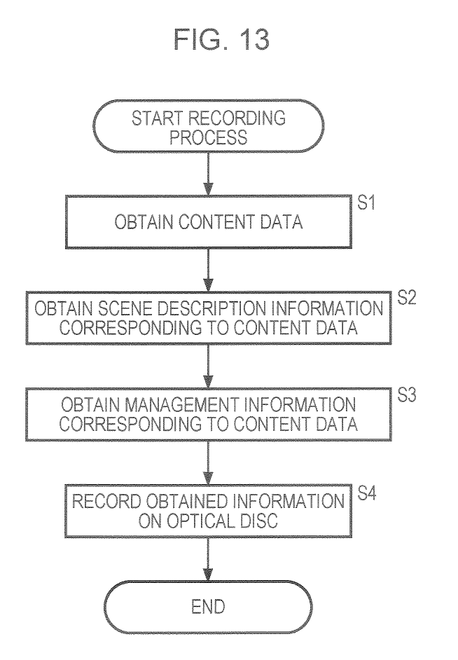

Next, a description will be given, with reference to the flowchart in FIG. 13, of a recording process to be performed by the recording apparatus 1 of FIG. 1.

In step S1, the data obtaining section 23 of the recording apparatus 1 obtains content data and supplies it to the encoder 24, and also notifies the controller 21 of the fact that the content data has been obtained. Under the control of the controller 21, the encoder 24 encodes the supplied content data and supplies it to the buffer 25. The buffer 25 temporarily stores the supplied, encoded content data.

In step S2, the controller 21 obtains scene description information corresponding to the content data. More specifically, the controller 21 obtains the scene description information obtained by the data obtaining section 23 or input by the user using the operation input section 22.

In step S3, the controller 21 obtains management information corresponding to the content data. More specifically, the controller 21 obtains management information obtained by the data obtaining section 23 or input by the user using the operation input section 22.

In step S4, the recording controller 26 records on the optical disc 11, the encoded content data buffered in the buffer 25 and the scene description information and the management information obtained by the controller 21, that is, information obtained steps S1 to S3. The processing is then completed.

As a result of such processing, the content data as well as the above-described scene description information is recorded on the optical disc 11.

Furthermore, it is also possible to record the content data, the scene description information, as well as management information used to reproduce the content data, for example, a playlist, on the optical disc 11.

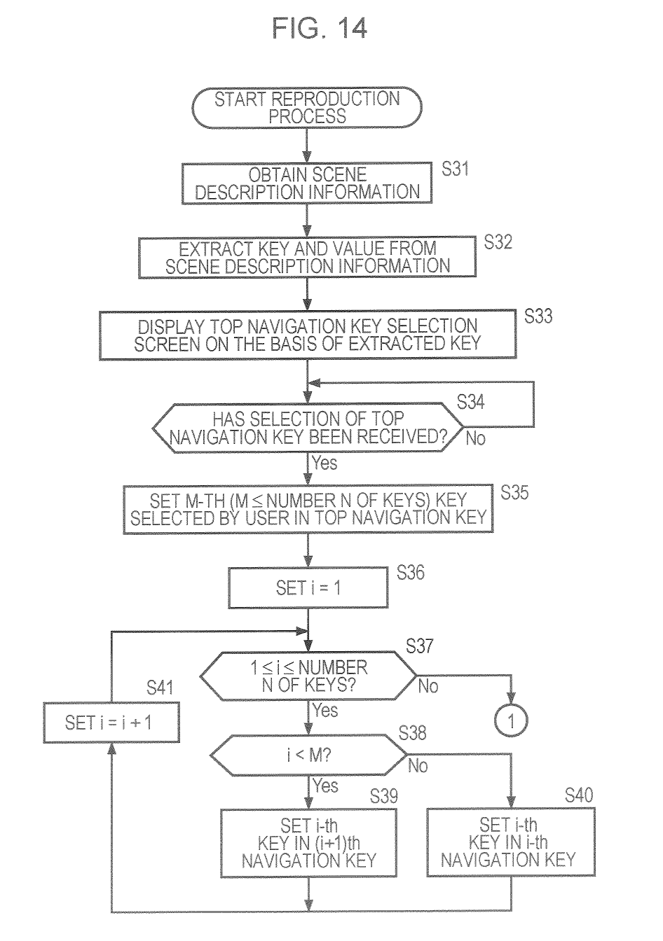

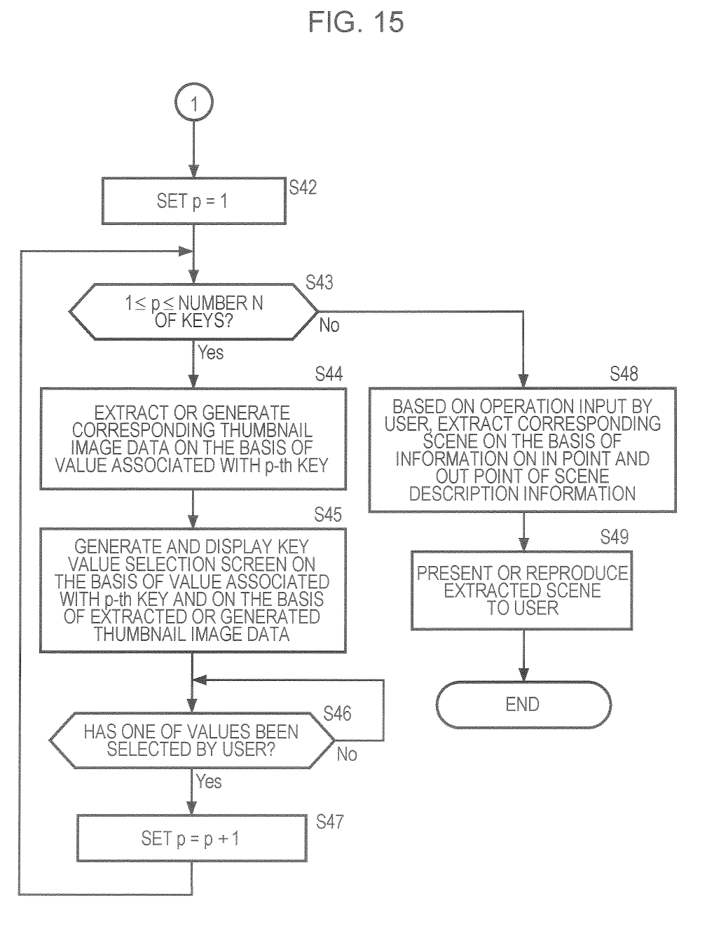

Next, a description will now be given, with reference to the flowcharts in FIGS. 14 and 15, of the reproduction process of the reproduction apparatus 41 described with reference to FIGS. 7 and 8.

In step S31, the scene description information obtaining section 81 obtains scene description information and supplies it to the navigation hierarchy controller 84. More specifically the reproduction controller 54 reproduces the scene description information recorded on the loaded optical disc and supplies it to the controller 51.

In step S32, the navigation hierarchy controller 84 extracts a key and a value from the supplied scene description information and supplies them to the navigation screen display controller 85.

In step S33, on the basis of the key extracted in step S32, the navigation screen display controller 85 controls the display of the top navigation key selection screen 101 described with reference to FIG. 9.

In step S34, the operation input obtaining section 83 determines whether or not the selection of the top navigation key from the user who has referred to the top navigation key selection screen 101 has been received. In other words, the controller 51 determines whether or not the selection of the top navigation key has been received from the user on the basis of the operation input by the user which is supplied from the operation input section 52 When it is determined in step S34 that the selection of the top navigation key has not been received from the user, the process of step S34 is repeated until it is determined that the selection of the top navigation key is received from the user.

When it is determined in step S34 that the selection of the top navigation key has been received from the user, in step S35, the operation input obtaining section 83 notifies the navigation hierarchy controller 84 of the key selected by the user. Thus, the navigation hierarchy controller 84 sets the M-th key (M is an integer corresponding to the key ID of the key selected by the user, 1≦M≦the number N of keys) selected by the user in the top navigation key.

In step S36, the navigation hierarchy controller 84 sets a variable i corresponding to the ID of the key to which a virtual hierarchical structure is assigned, to i=1.

In step S37, the navigation hierarchy controller 84 determines whether or not 1≦i≦the number N of keys.

When it is determined in step S37 that 1≦i≦the number N of keys, in step S38, the navigation hierarchy controller 84 determines whether or not i<M.

When it is determined in step S38 that i<M, in step S39, the navigation hierarchy controller 84 sets the i-th key in the (i+1)th navigation key, and the process then proceeds to step S41.

When it is determined in step S38 that i<M is not true, in step S40, the navigation hierarchy controller 84 sets the i-th key in the i-th navigation key.

After the process of step S39 or S40, in step S41, the navigation hierarchy controller 84 sets the variable i corresponding to the ID of the key to which a virtual hierarchical structure is assigned, to i=i+1. The process then returns to step S37, and processing of step S37 and subsequent steps is repeated.

When it is determined in step S37 that 1≦i≦the number N of keys is not true, in step S42, the navigation hierarchy controller 84 supplies the information on the set virtual hierarchical structure to the navigation screen display controller 85. The navigation screen display controller 85 sets a variable p indicating the depth of the virtual hierarchy to which the key belongs/to p=1.

In step S43, the navigation screen display controller 85 determines whether or not 1≦p≦the number N of keys.

When it is determined in step S43 that 1≦p≦the number N of keys, in step S44, on the basis of the value associated with the p-th key, the thumbnail image data obtainer/generator 82 extracts or generates corresponding thumbnail image data and supplies it to the navigation screen display controller 85. More specifically, for example, when the p-th key is “scene” and the associated values are “homerun” and “strikeout”>the thumbnail image data obtainer/generator 82 extracts thumbnail image data corresponding to “homerun” and “strikeout” from the scene description information or generates thumbnail image data by extracting corresponding frame image data from the content data on the basis of the IN point of the corresponding scene, and supplies it to the navigation screen display controller 85.

In step S45, on the basis of the value associated with the p-th key and the extracted or generated thumbnail image data, the navigation screen display controller 85 generates display screen data corresponding to the key value selection screen 121, 141, or 146 described with reference to FIGS. 10 to 12 and controls the display of the corresponding display screen.

In step S46, the operation input obtaining section 83 determines whether or not the user who has referred to the key value selection screen 121, 141, or 146 has selected any one of the keys. When it is determined in step S46 that no value has been selected by the user, the process of step S46 is repeated until the value is selected.

When it is determined in step S46 that the value has been selected by the user, in step S47, the operation input obtaining section 83 notifies the navigation hierarchy controller 84 of the value selected by the user. Therefore, the navigation hierarchy controller 84 sets the variable p indicating the depth of the virtual hierarchy to which the key belongs, to p=p+1. The process then returns to step S43, and processing of step S43 and subsequent steps is repeated.

When it is determined in step S43 that 1≦p≦the number N of keys is not true, in step S48, the navigation hierarchy controller 84 supplies the value of the key selected by the user with respect to the key of each virtual hierarchy, to the reproduction controller 86. Therefore, on the basis of the operation input by the user, the reproduction controller 86 extracts all the records that satisfy the value selected by the user from the table corresponding to the scene description information and extracts the scenes corresponding to the records on the basis of the information on the IN point and the OUT point of the corresponding record of the scene description information.

In step S49, the reproduction controller 86 presents the extracted scenes, for example, as a list of corresponding thumbnail images, or reproduces the extracted scenes. The processing is then completed.

As a result of such processing, when the user searches for a desired scene, a GUI (for examples the top navigation key selection screen 101 described with reference to FIG. 9) is displayed so that the user can determine the sequence of the hierarchically organized navigation. On the basis of the display screen, it is possible for the user to easily determine the sequence of the hierarchically organized navigation so that the desired scene can be intuitively searched for. Then, a display screen (for examples the key value selection screen 121, 141, or 146 described with reference to FIGS. 10 to 12) to be used by the user to select the value corresponding to the key is displayed in accordance with the virtual hierarchical structure that is set on the basis of the top navigation key set as desired by the user. On the basis of the key value selected by the user who has referred to the display screens, a scene specified by the IN point and the OUT point is searched for, and the search result is presented to the user or the found scene is reproduced.

Furthermore, since not only the IN point, but also the OUT point is specified in the scene, on the basis of a plurality of found scenes, for example, a digest of a scene desired by the user, such as [homerun scene of Ichiro], can be easily generated. In this manner, in the reproduction apparatus 41, when compared with the case of the related art, it is possible to perform a scene search process having a high degree of freedom with a simple operation.

Here, only the top navigation key can be selected by the user, and the navigation sequence is assigned to the other keys on the basis of the key ID. In addition, for example, by repeatedly displaying a navigation key selection screen similar to the top navigation key selection screen 101 described with reference to FIG. 9 so that the selection of a key by the user can be received, it is possible for the user to assign a plurality of keys to the navigation of a plurality of hierarchies as desired.

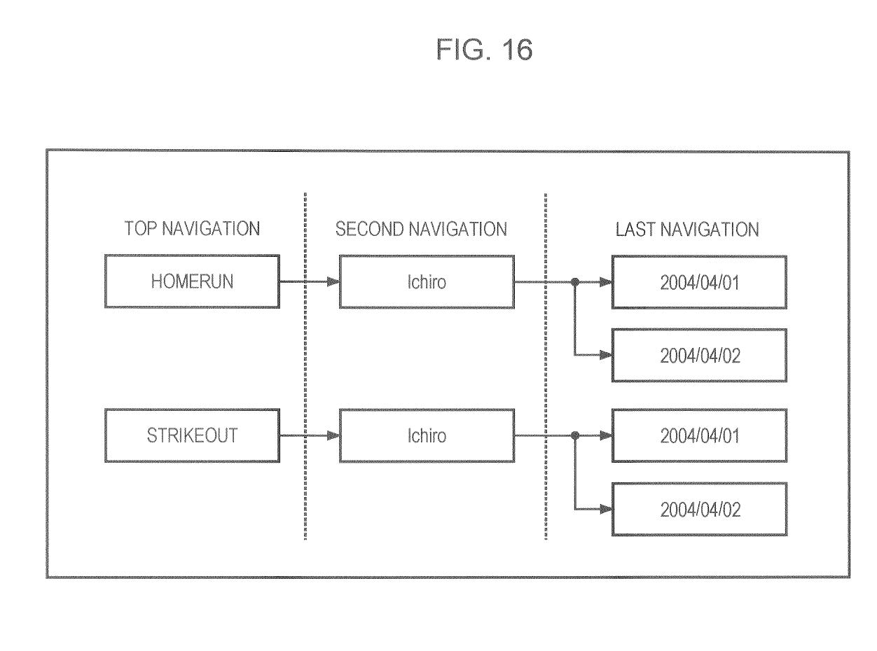

As a result of such processing, even if the scene description information is identical, for example, as shown in FIGS. 16 to 18, a plurality of navigations that are toggled on the basis of the operation input by the user can be implemented.

FIG. 16 shows a virtual hierarchical structure of key values when “scene” is selected as a top navigation key, a second navigation key is “player name”, and a final navigation key is “date”.

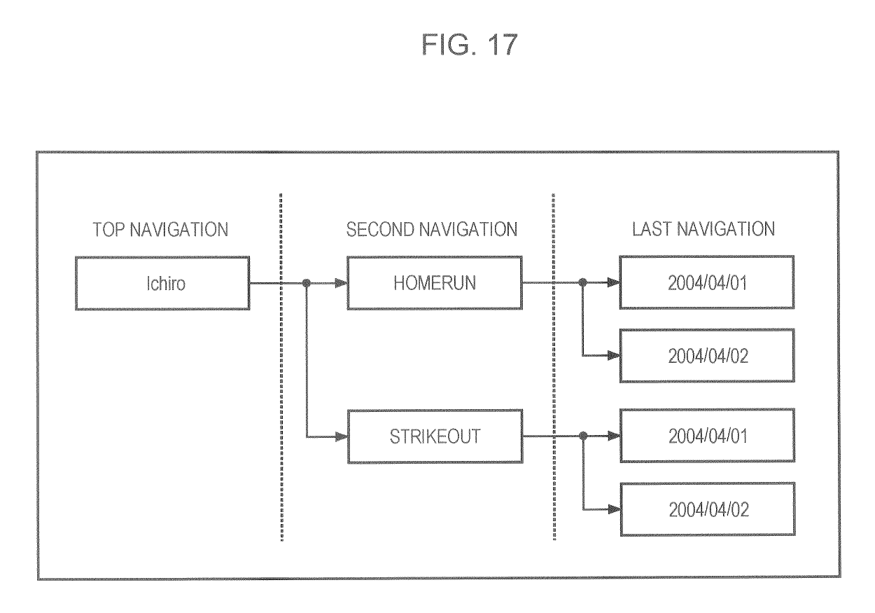

FIG. 17 shows a virtual hierarchical structure of key values when “player name” is selected as a top navigation key, a second navigation key is “scene”, and the final navigation key is “date”.

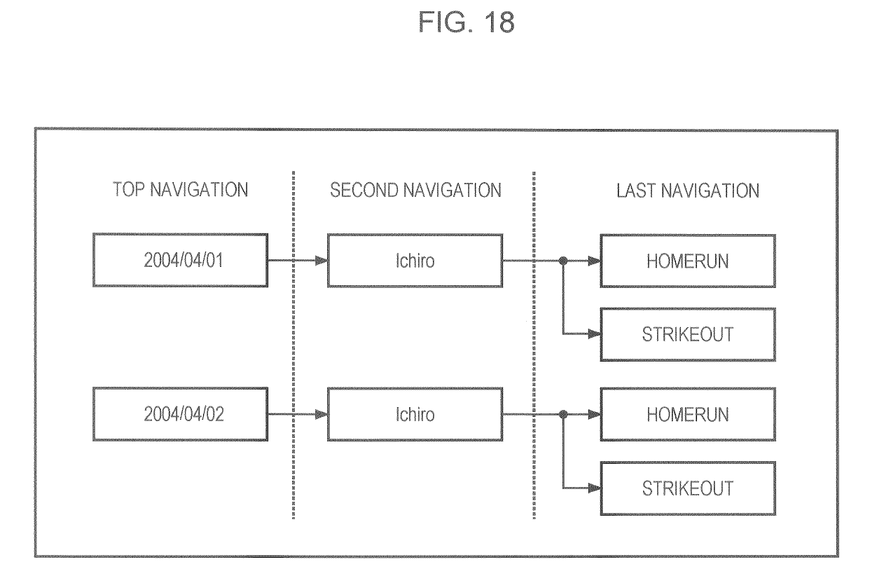

FIG. 18 shows a virtual hierarchical structure of key values when “date” is selected as a top navigation key, a second navigation key is “player name”, and a final navigation key is “scene”.

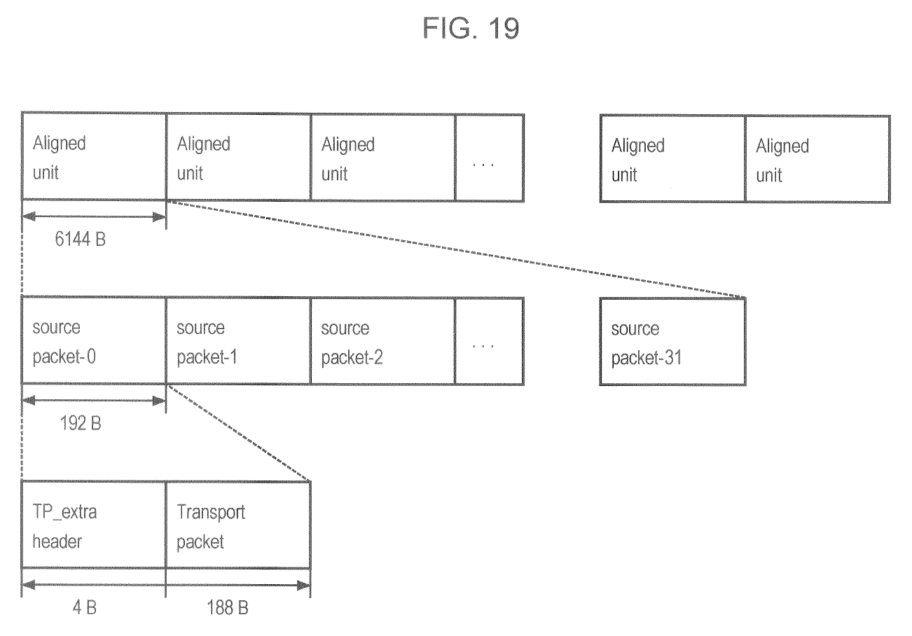

An And stream recorded on the optical disc 11 has a structure of an MPEG2 (Moving Picture Experts Group 2) transport stream shown in FIG. 19. The MPEG2 transport stream is formed of an integral number of aligned units The size of the aligned unit is 6144 bytes long (2048×3 bytes long), and the aligned unit starts from the first byte of a source packet. The source packet is 192 bytes long One source packet is formed of TP_extra_header and a transport packet. The TP_extra_header is 4 bytes long, and the transport packet is 188 bytes long One Aligned unit is formed of 32 source packets. Data of a video stream and an audio stream is packetized into MPEG2 PES (Packetized Elementary Stream) packets, and the PES packet is packetized into transport packets.

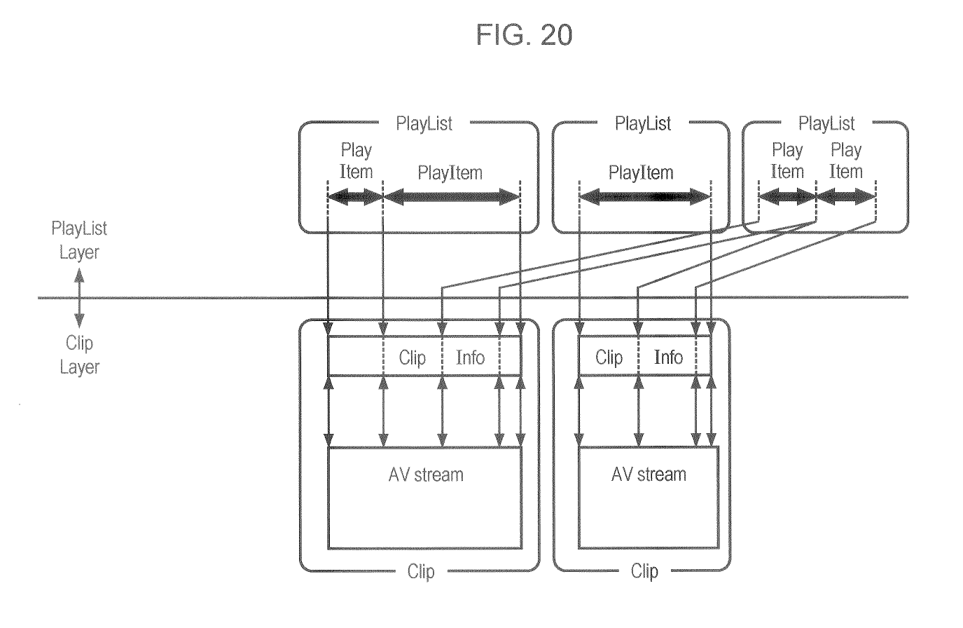

FIG. 20 shows an example of an application format of content that is recorded on the optical disc 11 by the recording apparatus 1 and that can be reproduced from the optical disc by the reproduction apparatus 41.

The application format has two layers of a playlist and a clip for the purpose of managing an AV stream. Here, the pair of one AV stream or text data, and clip information that is information associated therewith is considered as one object, and they are collectively referred to as a clip. Hereinafter, a data file of an AV stream will be referred to as an AV stream file. Furthermore, a data file of clip information will be referred to as a clip information file.

In general, a file used in a computer and the like is handled as a byte sequence Content of the AV stream file is loaded in the time axis, and the access point of the clip is mainly specified by a playlist using a time stamp.

When the access point within the clip is indicated by a playlist using a time stamp, the clip information file is used to find address information at which decoding should be started in the AV stream file from the time stamp.

The playlist is a collection of information indicating a reproduction section of an AV stream. Information indicating one reproduction section within a certain AV stream is called a playitem. The playitem is represented by a pair of an IN point (reproduction start point) and an OUT point (reproduction end point) of a reproduction section in the time axis. Therefore, as shown in FIG. 20, a playlist is formed of one or more playitems.

In FIG. 20, a first playlist shown in the first from the left is formed of two playitems. The first half portion and the second half portion of an AV stream contained in the first clip shown in the figure on the left side are referred to by the two playitems. A second playlist shown in the second from the left is formed of one playitem, and the whole AV stream contained in the second clip shown in the figure on the right side is referred to by the one playitem. A third playlist shown in the third from the left is formed of two playitems, and a predetermined portion of the AV stream contained in the first clip shown in the figure on the left side and a predetermined portion of the AV stream contained in the second clip shown in the figure on the right side are referred to by the two playitems.

A playitem is formed of at least one scene. In other words, a scene is not defined in such a manner as to extend over a plurality of playitems That is, on the optical disc 11, two types of time stamps of information on the IN point and the OUT point of a playitem described in the playlist and information on the IN point and the OUT point of scene description information can be recorded independently of each other.

In the content data having the structure described with reference to FIG. 20, in the related art, units of data, at which reproduction is possible, are playitems. That is, in the content data having the structure described with reference to FIG. 20, usually, the halfway point of a playitem cannot be specified as a reproduction start point. However, by providing the above-described scene description information it is possible to specify the reproduction start point or the reproduction section of content data at a scene whose division is smaller than a playitem as necessary.

That is, the recording apparatus 1 can record a playlist as management information together with content data and the above-described scene description information on the optical disc 11 by the process described with reference to FIG. 13. Furthermore, in the reproduction apparatus 41 to which the optical disc 11 on which a playlist is recorded as management information together with content data and the scene description information is loaded, a playlist is referred to, and content data is reproduced on the basis of the information on the IN point and the OUT point of the playitem described in the playlist. Also, similarly to the processes described with reference to FIGS. 14 and 15, by using the information on the IN point and the OUT point of the scene description information, it is possible to search for and reproduce a desired scene of the content data that is reproduced on the basis of the playlist.

Next, a description will be given of a case in which the data structure of scene description information recorded on the optical disc 11 is generalized and defined. A key and a value corresponding to the key can be freely defined by a content producer who records content, scene description information, and playlists on the optical disc 11 by using the recording apparatus 1. Hereinafter it is assumed that SceneStartTime indicates an IN point and SceneStartTime+duration indicates an OUT point.

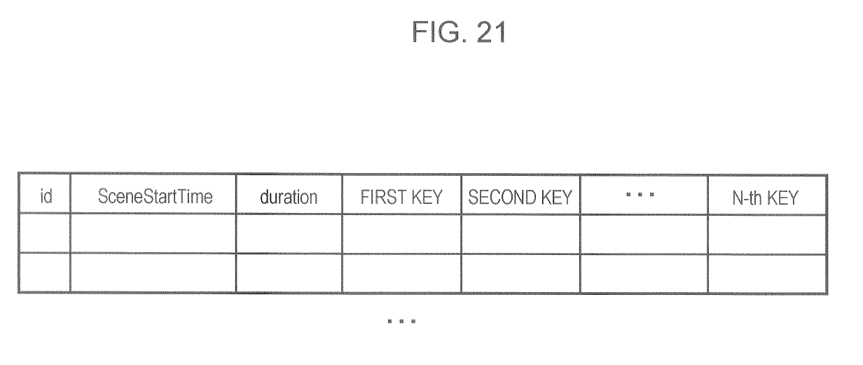

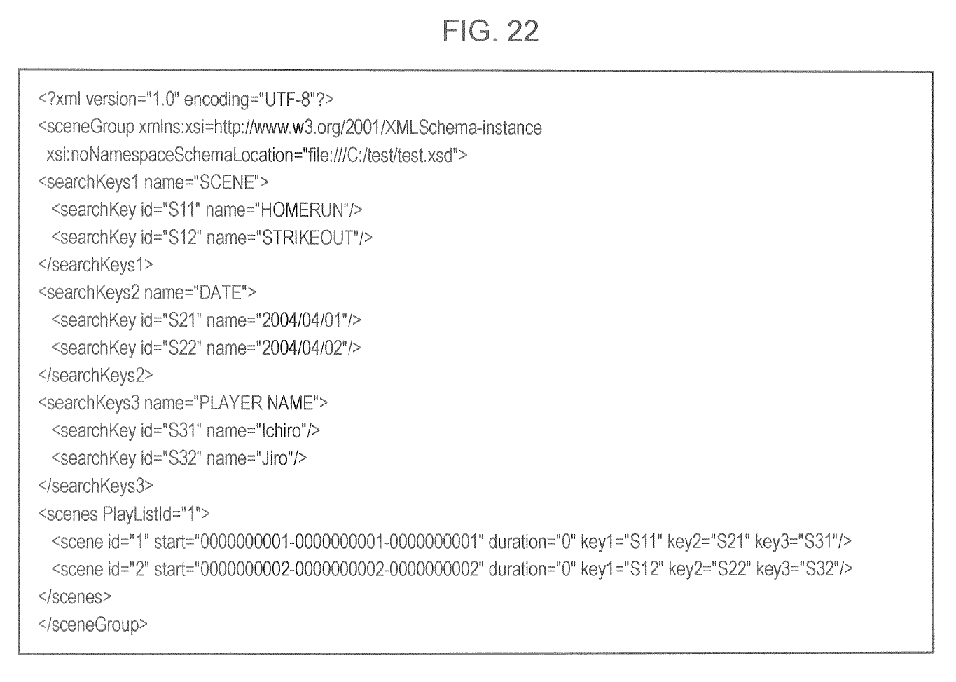

Scene description information can be described, for example, in a well-formed XML format. FIG. 21 shows an example of a table of scene description information including scene ID, SceneStartTime, duration, and values corresponding to each of a plurality of keys. An example of a data structure when a scene description information table having a structure shown in FIG. 21 is described in a well-formed XML format is shown in FIG. 22. In FIG. 22, the number of keys is limited to 3.

As shown in FIG. 22, first, the scene description information described in a well-formed XML format begins with XML declaration described as <?xml version information encoding declaration?>. The succeeding elements of searchKeys1/searchKeys2/searchKeys3 correspondingly define attributes for three keys. That is, name attributes among these elements specify the title of a key. Here, as the titles of the keys, “scene”, “date”, and “player name” are specified. id attributes of the searchKey element is an ID for the value of the key, the ID being specified by the content producer. Name attributes specify values of keys, that is, for example, “strikeouts”, “homerun”, “Ichiro”, “Jiro”, “2004 Apr. 1”, “2004 Apr. 2”, and the like, which are search keys when the user searches the content data

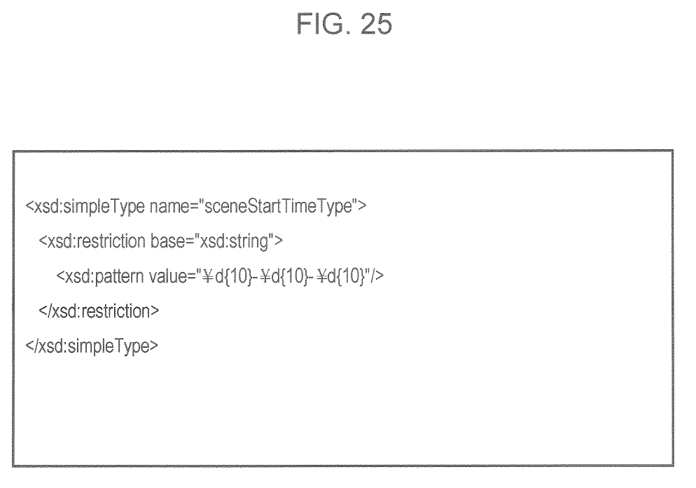

PlayListId attributes within the scene element specify an ID of a playlist that is a reproduction unit. Id attributes within the scene element is an ID of a scene specified by the content producer. Start attributes specify the start time of a scene, that is information corresponding to the IN point. Duration attributes specify the reproduction time of the scene in units of milliseconds That is, it is possible to determine information corresponding to the OUT point on the basis of the start attributes and the duration attributes. The type representation using an XML schema of the start attributes will be described later with reference to FIG. 25. Key1/key2/key3 attributes specify the ID of the search key that is necessary when each scene is searched for, and each key needs to correspond to the id attributes of the searchKey element.

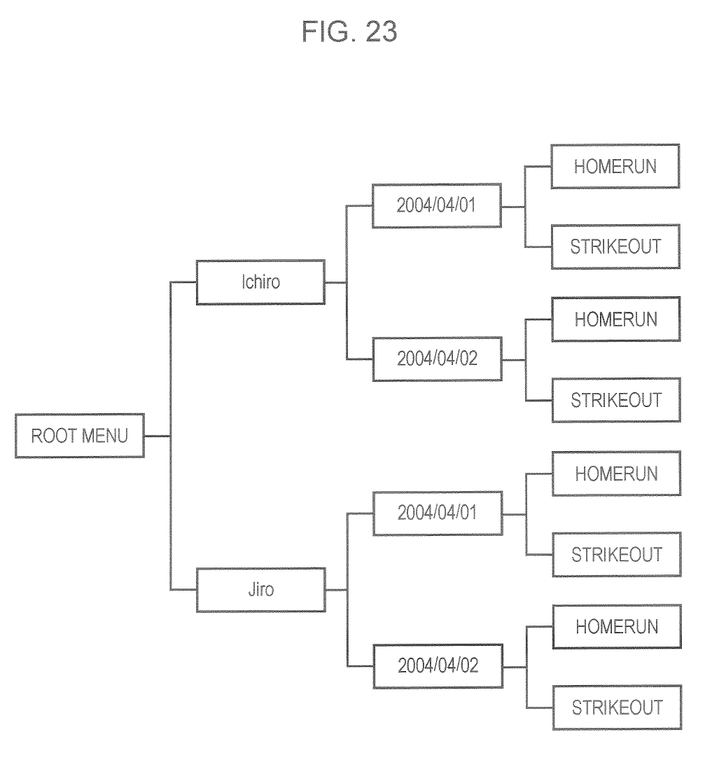

In the case of an XML document, it is possible to implement a navigation menu display of three layers (excluding, for example, the root menu displayed to select the top navigation key) shown in FIG. 23. The order of the hierarchies can be toggled on the basis of the operation input by the user in the manner described above.

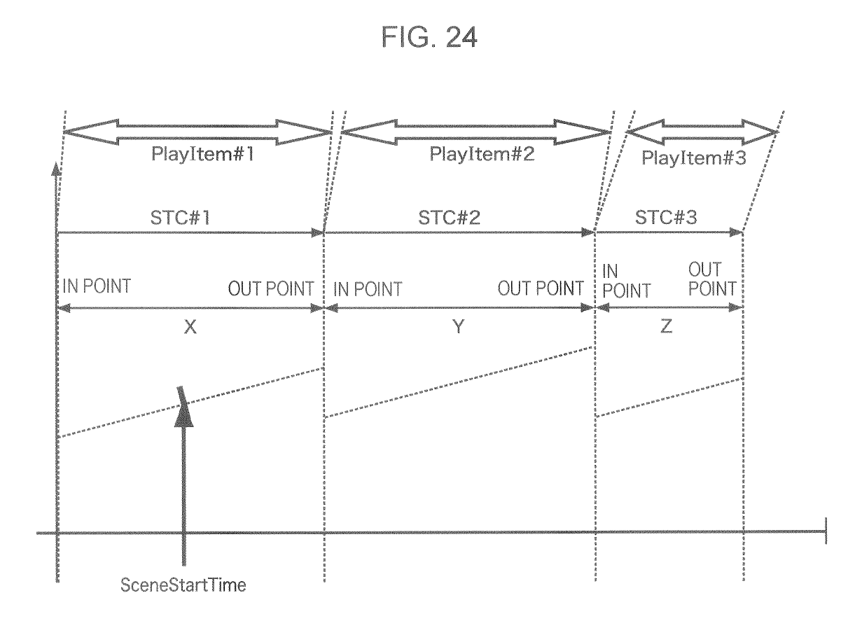

For the time axis in the reproduction of content data to be reproduced on the basis of a playlist, for example, a definition similar to PlayListMark can be used. That is, as shown in FIG. 24, SceneStartTime that is the start time of a scene specified by the start attributes can be defined in the halfway point of a playitem, and is indicated by a time stamp clocked by an STC (System Time Clock) defined for each playitem Here, the type representation of SceneStartTime in the XML schema can be represented by, for example a syntax shown in FIG. 25.

In FIG. 25, in the portion described as “¥{10}-¥{10}-¥{10}”, three integers of 10 digits are specified at three places. The first integer is specified in such a manner that the ID of the playitem in which SceneStartTime exists is zero-suppressed to 10 digits. Then, the second integer is specified in such a manner that the time stamp clocked by a clock of 45 kHz is zero-suppressed to 10 digits. The third integer is specified in such a manner that the PID of a stream to be reproduced is zero-suppressed to 10 digits. For example, in FIG. 25, when “0000000001-0000000000-0000000002” is specified in the portion described as “¥{10}-¥{10}-¥{10}”, the reproduction apparatus 41 starts to reproduce a stream having a PID of 2 from the point of time stamp 0 in the playitem whose PlayItem id is 1.

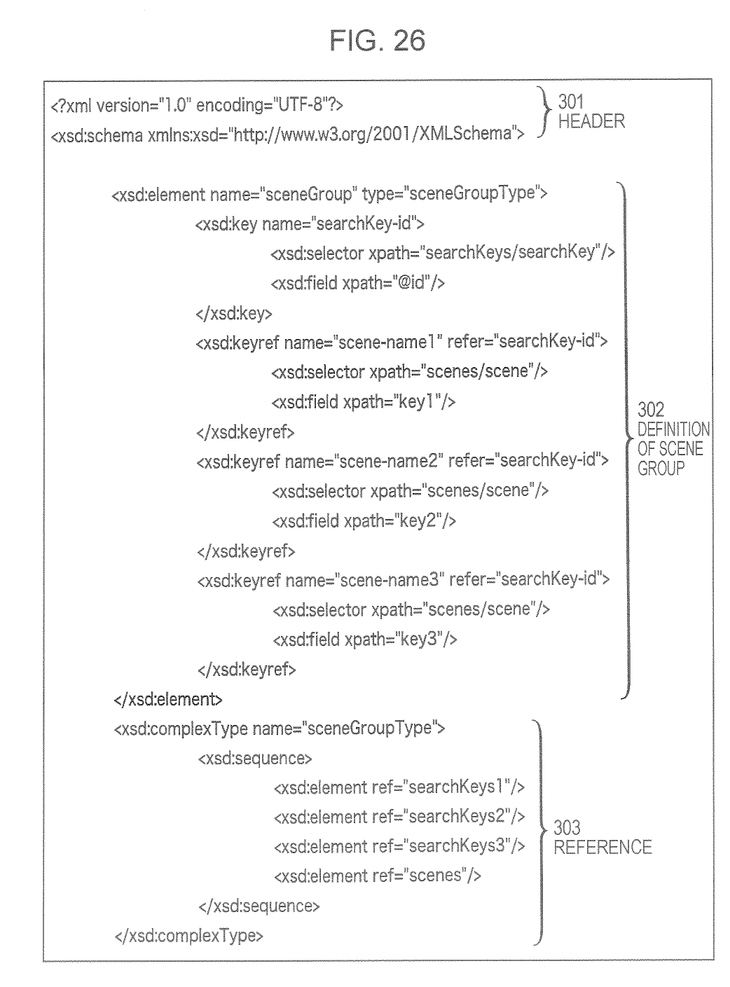

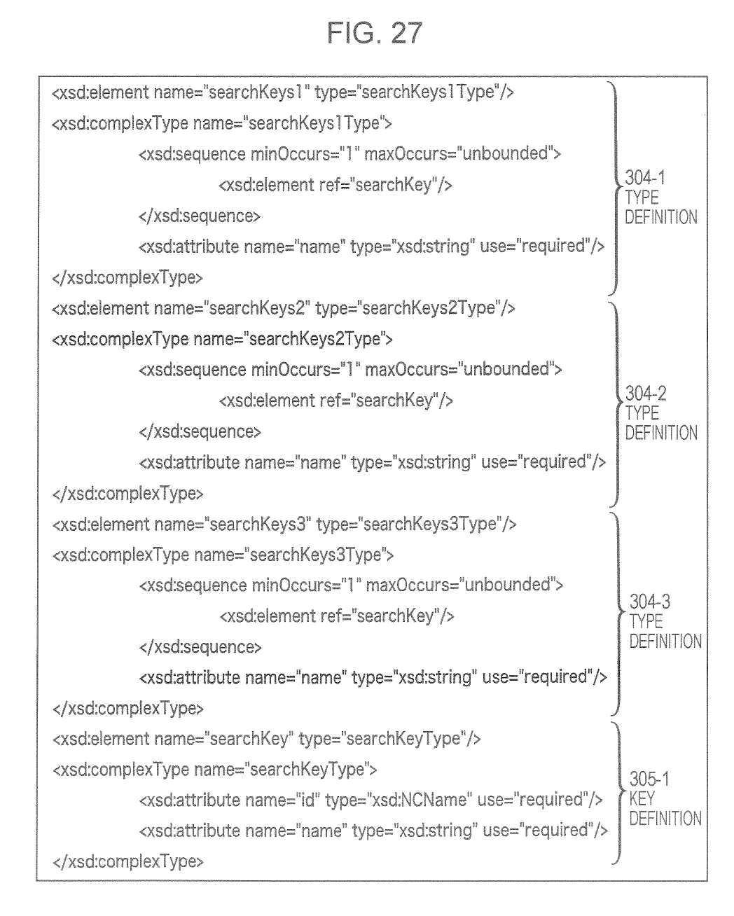

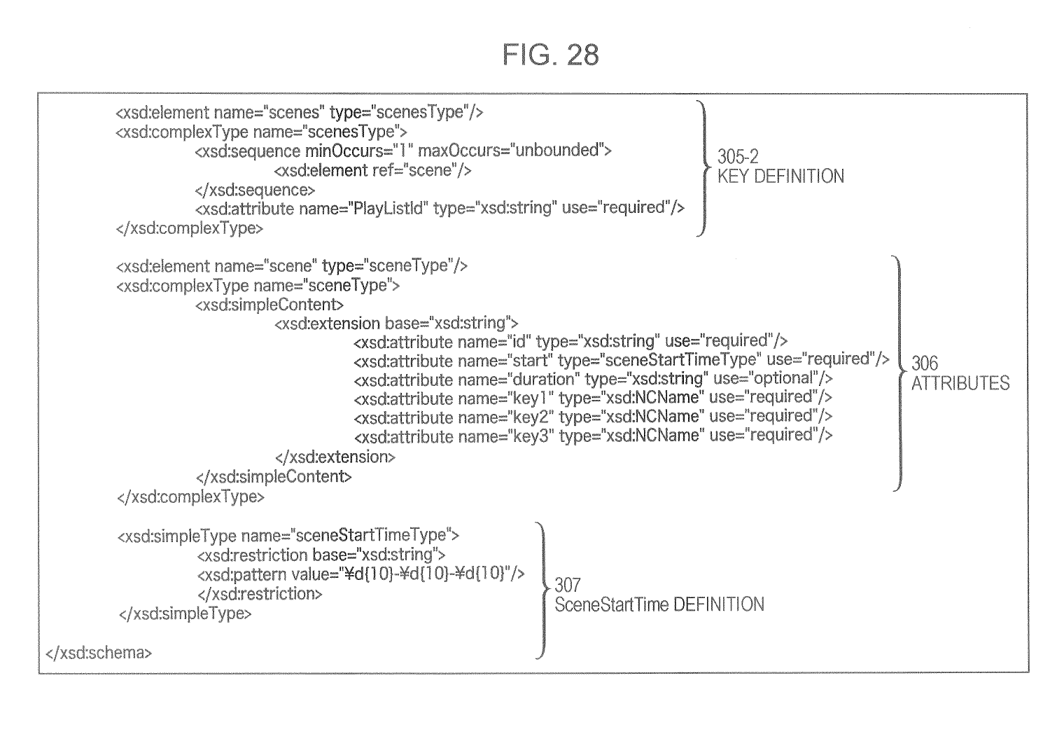

Furthermore, scene description information can be described by a tagged language in an XML format. That is, the data structure of the scene description information can be defined by, for example, an XML schema shown in FIGS. 26 to 28. However, the data structure shown in FIGS. 26 to 28 is effective only in the case of a so-called linear title in which the jump destination can be specified and is ineffective in the case of so-called interactive content data in which the jump destination cannot be specified.

In the scene description information described by a tagged language in an XML format, first, a header 301 containing an XML declaration described as <?xml version information encoding declaration?> is described, and then a definition 302 of a scene group is described. In the definition 302 of the scene group, it is possible to define three keys (for example, “date”, “scene” and “player name”) Furthermore, as described with reference to FIG. 6, when the scene description information is described in a relational database format, in the definition 302 of the scene group, path information indicating which table should be referred to is described in each of the keys.

Next, information regarding an external reference is described as a reference 303. Then, type definitions of three keys described in the definition 302 of the scene group are described correspondingly in the type definitions 304-1 to 304-3.

Next, the definitions of the values of the keys, that is, text data corresponding to the keywords (for example, strikeout, homerun, Ichiro, Jiro, 2004 Apr. 1, and 2004 Apr. 2), is described in the key definitions 305-1 and 305-2.

Next, by deriving the type by expansion, attribute information of each of ID, SceneStartTime, and duration, and keys 1 to 3 is described in attributes 306. Finally, similarly to the case described with reference to FIG. 25, the type of SceneStartTime is defined by a SceneStartTime definition 307.

Since XML is such that the rule of tags is strict, processing of a processor is simplified by using XML. Furthermore, since data is structured by using XML, searching for data becomes easy. Furthermore, since there has been a demand for XML to be not dependent on a specific language or environment, attributes of xml: lang and “language identification code” for describing the values of the attributes are provided so as to be designed to be capable of handling multiple languages such as English and Japanese. Consequently, it is possible to flexibly cope with multiple languages. That is, by describing scene description information by XML, processing of the controller 51, in particular, a data search process, becomes easy, and it is possible to flexibly cope with multiple languages.

As described above, by applying the present invention, it is possible to set a plurality of search keys in a scene of one section specified by an IN point and an OUT point, and the order of hierarchically organized navigation can be determined by the user, thereby increasing the degree of freedom Of a scene search. Furthermore, by applying the present invent on, it is possible to generate and display a GUI for providing a hierarchically organized navigations to the user.

Since not only an IN point, but also an OUT point can be set as a time stamp for specifying a scene, it is possible to specify not only the reproduction start position, but also the reproduction section.

As a result of the above, one section specified by the In point and the Out point may be shorter than, for example, a cell or a playitem, which is defined as a reproducible section in the related art (that is, a cell and a playitem may contain a plurality of sections specified by an In point and an Out point) On the basis of this section, it is possible to easily generate, for example, a digest of a scene desired by the user.

Furthermore, the scene description information may contain a thumbnail image that represents the content of the scene or that corresponds to the video image of the IN point for each scene. As a result of the above, it is possible to easily display a thumbnail corresponding to the key value on the GUI screen, so that the selection of the search key by the user becomes easier. Furthermore, copyright or billing data attributes may be attached to the scene description information By attaching copyright or billing data attributes to the scene description information it is possible to introduce copyright management in units of scenes.

Furthermore, by describing scene description information using XML, it is possible to flexibly handle multiple languages by using a plurality of labels, and processing of the controller 51, in particular, a data search process, becomes easy.

The above-described series of processes can also be performed by software. For the software, a program forming the software is installed from a recording medium into a computer that is incorporated in specialized hardware or into, for example, a general-purpose computer capable of performing various kinds of functions by installing various kinds of programs.

As shown in FIGS. 1 and 7, the recording medium is formed of the removable medium 28 constituted by a magnetic disk (including a flexible disk), an optical disc (including a CD-ROM (Compact Disc-Read Only Memory), and a DVD (Digital Versatile Disc)), a magneto-optical disc (including an MD (trademark)), or a semiconductor memory, in which a program is recorded, the recording medium being distributed to provide the program to the user separately from the computer.

In this specification the steps describing a program recorded on a recording medium include not only processing which is carried out chronologically in the written order but also processing which is executed in parallel or individually although they are not necessarily processed chronologically.

1. A reproduction apparatus for reproducing content data containing a plurality of scenes, the content data being recorded on a recording medium, the reproduction apparatus comprising:
an operation input section configured to accept an operation input by a user;
an obtaining section configured to reproduce and obtain, from the recording medium, information including the start point information and the end point information of the scene contained in the content data recorded on the recording medium, keys used to search for the scene, and key values corresponding to the keys;
a display controller configured to control the display of a display screen on the basis of the keys and the key values obtained by the obtaining section;
a hierarchy organization section configured to organize a virtual hierarchical structure of the keys on the basis of the operation input by the user, the operation being input by means of the operation input section; and
a reproduction controller configured to control the reproduction output of a predetermined scene included in the content data recorded on the recording medium on the basis of the operation input by the user by means of the operation input section and on the basis of the information,
wherein the display controller controls the display of a first display screen with which the user selects one of the keys obtained by the obtaining section,
the hierarchy organization section organizes a virtual hierarchical structure of the keys on the basis of the key selected by the user who has referred to the first display screen whose display is controlled by the display controller, the key being operated and input by means of the operation input section,
the display controller controls the display of a second display screen with which the user selects one of the key values corresponding to the keys in accordance with the virtual hierarchical structure of the keys, the virtual hierarchical structure being organized by the hierarchy organization section, and
the reproduction controller detects the start point information and the end point information of a predetermined scene corresponding to the key value on the basis of the key value selected by the user who has referred to the second display screen whose display is controlled by the display controller and on the basis of the information, the key being operated and input by means of the operation input section, and controls the reproduction output of the predetermined scene.

2. The reproduction apparatus according to claim 1, further comprising a thumbnail image data generator configured to generate thumbnail image data corresponding to each of the scenes on the basis of the start point information contained in the information and the content data,
wherein the display controller further controls the display of a thumbnail image corresponding to the thumbnail image data generated by the thumbnail image data generator.

3. The reproduction apparatus according to claim 1, wherein the information further comprises thumbnail image data corresponding to the scene, the reproduction apparatus further comprises a thumbnail image data obtaining section configured to obtain the thumbnail image data contained in the information, and
wherein the display controller further controls the display of a thumbnail image corresponding to the thumbnail image data obtained by the thumbnail image data obtaining section.

4. The reproduction apparatus according to claim 1, wherein, in addition to the content data and the information, management information for managing the content data is further recorded on the recording medium.

5. The reproduction apparatus according to claim 4, wherein the management information contains information indicating the reproduction start position and the reproduction completion position in predetermined reproduction units containing at least one scene.

6. The reproduction apparatus according to claim 1, wherein the information is described in XML.

7. A reproduction method for use in a reproduction apparatus for reproducing content data containing a plurality of scenes, the content data being recorded on a recording medium, the reproduction method comprising:
an obtainment control step of controlling the obtainment, from the recording medium, information including the start point information and the end point information of the scene contained in the content data recorded on the recording medium, keys used to search for the scene, and key values corresponding to the keys;
a first display control step of controlling the display of a first display screen with which the user selects one of the keys whose obtainment is controlled by the process of the obtainment control step;
a hierarchy organization step of organizing a virtual hierarchical structure of the keys on the basis of the key selected by the user who has referred to the first display screen whose display is controlled by the process of the first display control step;
a second display control step of controlling the display of a second display screen with which the user selects one of the key values corresponding to the keys on the basis of the virtual hierarchical structure of the keys, the virtual hierarchical structure being organized by the process of the hierarchy organization step;
a detection step of detecting the start point information and the end point information of a predetermined scene corresponding to the key value on the basis of the key value selected by the user who has referred to the second display screen whose display is controlled by the second display control step and on the basis of the information; and
a reproduction control step of extracting the predetermined scene and controlling the reproduction output of the predetermined scene on the basis of the start point information and the end point information of the predetermined scene detected by the process of the detection step.

8. A program storage medium having recorded thereon a program for enabling a computer to perform a process for reproducing content data containing a plurality of scenes, the content data being recorded on a recording medium, the process comprising:
an obtainment control step of controlling the obtainment, from the recording medium, information including the start point information and the end point information of the scene contained in the content data recorded on the recording medium, keys used to search for the scene, and key values corresponding to the keys;
a first display control step of controlling the display of a first display screen with which the user selects one of the keys whose obtainment is controlled by the process of the obtainment control step;
a hierarchy organization step of organizing a virtual hierarchical structure of the keys on the basis of the key selected by the user who has referred to the first display screen whose display is controlled by the process of the first display control step;
a second display control step of controlling the display of a second display screen with which the user selects one of the key values corresponding to the keys on the basis of the virtual hierarchical structure of the keys the virtual hierarchical structure being organized by the process of the hierarchy organization step;
a detection step of detecting the start point information and the end point information of a predetermined scene corresponding to the key value on the basis of the key value selected by the user who has referred to the second display screen whose display is controlled by the second display control step and on the basis of the information; and
a reproduction control step of extracting the predetermined scene and controlling the reproduction output of the predetermined scene on the basis of the start point information and the end point information of the predetermined scene detected by the process of the detection step.

9. A program for enabling a computer to perform a process for reproducing content data containing a plurality of scenes, the content data being recorded on a recording medium, the process comprising:
an obtainment control step of controlling the obtainment, from the recording medium, information including the start point information and the end point information of the scene contained in the content data recorded on the recording medium, keys used to search for the scenes and key values corresponding to the keys;
a first display control step of controlling the display of a first display screen with which the user selects one of the keys whose obtainment is controlled by the process of the obtainment control step;
a hierarchy organization step of organizing a virtual hierarchical structure of the keys on the basis of the key selected by the user who has referred to the first display screen whose display is controlled by the process of the first display control step;
a second display control step of controlling the display of a second display screen with which the user selects one of the key values corresponding to the keys on the basis of the virtual hierarchical structure of the keys, the virtual hierarchical structure being organized by the process of the hierarchy organization step;
a detection step of detecting the start point information and the end point information of a predetermined scene corresponding to the key value on the basis of the key value selected by the user who has referred to the second display screen whose display is controlled by the second display control step and on the basis of the information; and
a reproduction control step of extracting the predetermined scene and controlling the reproduction output of the predetermined scene on the basis of the start point information and the end point information of the predetermined scene detected by the process of the detection step.

10. A reproduction apparatus capable of reproducing content data formed of data in predetermined reproduction units defined by management information, the content data being recorded on a recording medium the reproduction apparatus comprising:
an obtaining section configured to obtain the start point information and the end point information of a scene contained in the content data on the basis of description information recorded together with the content data and the management information on the recording medium; and
a reproduction controller configured to reproduce the content data on the basis of the start point information and the end point information obtained by the obtaining section,
wherein the predetermined reproduction units constituting the content data contain at least one scene divided by the start point information and the end point information.

11. The reproduction apparatus according to claim 10, wherein the start point information and the end point information are described in XML.

12. A reproduction method for use in a reproduction apparatus for reproducing content data formed of data in predetermined reproduction units defined by management information the content data being recorded on a recording medium, the reproduction method comprising
an obtainment control step of controlling the obtainment of the start point information and the end point information of a scene contained in the content data on the basis of description information recorded together with the content data and the management information on the recording medium; and
a reproduction control step of reproducing the content data on the basis of the start point information and the end point information obtained by the process of the obtainment control step,
wherein the predetermined reproduction units constituting the content data contain at least one scene divided by the start point information and the end point information.

13. A program storage medium having recorded thereon a program for enabling a computer to perform a process for reproducing content data formed of data in predetermined reproduction units defined by management information, the content data being recorded on a recording medium, the process comprising:
an obtainment control step of controlling the obtainment of the start point information and the end point information of a scene contained in the content data on the basis of description information recorded together with the content data and the management information on the recording medium; and
a reproduction control step of reproducing the content data on the basis of the start point information and the end point information obtained by the process of the obtainment control step.

14. A program for enabling a computer to perform a process for reproducing content data in predetermined reproduction units defined by management information the content data being recorded on a recording medium, the process comprising:
an obtainment control step of controlling the obtainment of the start point information and the end point information of a scene contained in the content data on the basis of description information recorded together with the content data and the management information on the recording medium; and
a reproduction control step of reproducing the content data on the basis of the start point information and the end point information obtained by the process of the obtainment control step.

15. A recording apparatus for recording content data on a recording medium, the recording apparatus comprising
a first obtaining section configured to obtain the content data;
a second obtaining section configured to obtain information including the start point information and the end point information of a scene contained in the content data, keys used to search for the scene, and key values corresponding to the keys; and
a recorder for recording the information obtained by the second obtaining section together with the content data obtained by the first obtaining section on the recording medium.

16. The recording apparatus according to claim 15, wherein the information is described in XML.

17. The recording apparatus according to claim 15, wherein the second obtaining section further obtains management information of the content, and
the recorder further records the management information together with the scene description information and the content data on the recording medium

18. A recording medium that can be loaded into a predetermined reproduction apparatus and on which content data that can be reproduced by the reproduction apparatus is recorded,
wherein the information including the start point information and the end point information of a scene contained in the content data, keys used to search for the scene, and key values corresponding to the keys are recorded in such a manner as to be associated with the content data.

19. The recording medium according to claim 18 wherein the information is described in XML.
